(19) United States
(12) Patent Application Publication
(10) Pub. No.: US 2024/0326525 A1
(43) Pub. Date: Oct. 3, 2024

(54) AUTOMOTIVE TIRE INFLATION DEVICE

(71) Applicant: Nantong Xinyue Technology Co., Ltd., Nantong City (CN)

(72) Inventor: Yue Yan, Nantong City (CN)

(21) Appl. No.: 18/460,540

(22) Filed: Sep. 2, 2023

(30) Foreign Application Priority Data
Mar. 27, 2023 (CN) 202320625794.5

(51) Int. Cl. B60C 23/12; B60C 23/04

(52) U.S. Cl. CPC B60C 23/127; B60C 23/04

(57) ABSTRACT

An automotive tire inflation device is provided, including an electric inflation module, a fixing module, a power supply module, a sensing module, a control module, and a data transmission module. In the present disclosure, it is possible to inflate the tire while in motion, avoiding the driver from stopping for a long time to replace the spare tire or inflate. The fixing device can adjust the fixed position. Inflation can be started and stopped automatically. The inflation would stop when the tire is full, without the need for the driver to manually separate the inflating device. In addition, an alarm can be generated for abnormal situations, and all data and alarm information can be transmitted back to the cabin, timely, drivers can refer to the corresponding information to choose manual control or parking for maintenance.

### TECHNICAL FIELD

The present disclosure relates to the field of tire inflation technology, in particular to an automotive tire inflation device.

### BACKGROUND

Usually, in the case of a damaged tire or insufficient tire pressure, the driver needs to stop the vehicle and inflate the tire, and the spare tire needs to be replaced when severe air leakage occurs. In order to save space, new energy vehicles often no longer place spare tires and require drivers to repair the tires and inflate them with tire repair fluid. The above operations not only take a lot of time, but also cause unsafe factors in some road conditions.

After searching, some existing patented technologies for tire inflation are excerpted as follows:

CN208247874U discloses an automatic tire inflation device, which is equipped with an impeller driven by a motor inside the automatic tire inflation device, and a push rod and a push block are also sleeved inside the sliding sleeve, which can press air into the air pipe in two ways to make the inflation device more convenient to use.

CN203372017U discloses an automatic inflation hub, which is driven by the motor component to rotate the shell of the hub around the central axis, thereby driving the inflation pump to rotate around the cam, thereby achieving automatic inflation of the tire during wheel movement.

CN201212476Y discloses a scroll compressor automatic tire inflation device, which utilizes space reasonably, is safe and effective, and can be applied to vehicles with tires such as bicycles, electric vehicles, motorcycles, etc. When the tire pressure is low, it can automatically fill them with air.

CN2338194Y discloses a pneumatic tire self-inflation device when moving. When the contact point turns away from the ground, the tire returns to its original state, and the reset spring resets the pressure rod. When the pressure rod moves upwards, the upper row of teeth pushes a set of pressure reducing gears composed of three gears to rotate and drive the push rod moving up or down to push the piston to move inside the piston cylinder. The external air is sucked in through the air nozzle, and then inflated into the tire through a one-way valve.

The above devices still have the following disadvantages in use:
In the patent literature of CN208247874U, inflation cannot be achieved when the vehicle is running;
In the patent literature of CN203372017U and CN201212476Y, the fixing method is installed on the central shaft, which has poor universality and adaptability for different vehicle models;
In the patent literature of CN201212476Y, there is no sensor or tire pressure control algorithm, and manual separation is required after full inflation;
In the patent literature of CN2338194Y, passive devices have low controllability, and the changes in the contact shape between the wheel and the ground may affect travel. In response to the above issues, the present disclosure proposes an automotive tire inflation device.

### SUMMARY

The present disclosure provides an automobile tire inflation device, which solves the problems in existing technologies: it cannot achieve inflation during movement; the fixing method is installed on the central axis, causing poor universality and adaptability in response to the different vehicle models; without sensors and tire pressure control algorithms, manual separation is required after full inflation; it uses passive components with low controllability; the changes in the shape of the wheel in contact with the ground may affect the disadvantage of travelling.

The present disclosure provides the following technical solution:
An automotive tire inflation device, which includes an electric inflation module, a fixing module, a power supply module, a sensing module, a control module, and a data transmission module;
wherein the electric inflation module is configured to inflate the tire;
the fixing module is fixedly connected to an outer wall of the electric inflation module for fixing the electric inflation module on a wheel hub;
the control module is fixedly connected to the electric inflation module, configured to receive inputs from the sensing module, continuously monitor changes in tire pressure, and control the start and stop of the electric inflation module;
the sensing module is installed on the electric inflation module, configured to collect tire pressure and transmit the collected data to the control module;
the data transmission module is set on the electric inflation module, configured to send start and stop data of inflation and alarm signals to a cabin based on the inputs of the control module; and the data transmission module sends data to the cabin through wireless data transmission.
the power supply module is arranged on the electric inflation module, configured to provide electricity for the electric inflation module, the sensing module, the control module, and the data transmission module.

In an improvement of the technical solution, the electric inflation module includes an air pump, an inflation hose, and an air nozzle; one end of the inflation hose is connected to an outlet end of the air pump, the other end of the inflation hose is connected to the air nozzle, and the air nozzle is connected to a tire valve.

In an improvement of the technical solution, the fixing module includes a plurality of connecting bars fixedly connected to the outer wall of the air pump, with one end of each of the connecting bars far from the air pump contacts with the tire, and each of the connecting bars is fixed to the wheel hub through a plurality of adjustable length steel wires.

In an improvement of the technical solution, the power supply module includes a power supply and a power management module; the power supply is configured to provide electricity to the electric inflation module, the sensing module, the control module, and the data transmission module; and the power management module collects power consumption and remaining capacity of the power supply to send to the control module.

In an improvement of the technical solution, the data transmission module sends a control signal to manually control the start and stop of the electric inflation module to a controller according to a driver instruction.

In an improvement of the technical solution, each of the connecting bars is a retractable connecting bar.

It should be understood that the general description above and the detailed description in the following text are only illustrative and do not limit the present disclosure.

In the present disclosure, when in use, the connecting bars are fixed on the wheel hub through steel wires, the air nozzle is inserted on the tire valve, and the change in tire pressure is continuously monitored through the sensing module.

In the present disclosure, when the tire pressure is below a threshold (which can be set according to different tire types), the control module outputs a control signal to drive the electric inflation module to inflate the tire. If the tire pressure of the vehicle continues to decrease during inflation, the control module will generate an alarm signal.

In the present disclosure, if abnormal power consumption or insufficient remaining power is detected in the power supply module, the control module will generate an alarm signal. The control module is also responsible for driving the data transmission module and outputting the start and stop status of the electric inflation module, the power consumption of the power supply module, the remaining power of the power supply, and various alarm signals to the data transmission module, making it convenient to use.

In the present disclosure, it is possible to inflate the tire during movement, avoiding the driver from stopping for a long time to replace the spare tire or inflate the tire. The fixing device can adjust the fixed position without affecting the dynamic balance characteristics of the tire, and the device can be automatically started and stopped. When the tire is full, inflation stops without the need for the driver to manually separate the inflation device. In addition, an alarm will be generated when abnormal situation occurs, and all data and alarm information can be promptly transmitted back to the cabin, so that drivers can refer to the corresponding information to choose manual control or parking for maintenance.

### BRIEF DESCRIPTION OF THE DRAWINGS

FIG. 1 is a three-dimensional structural schematic diagram of an automotive tire inflation device provided by the embodiment of the present disclosure;

FIG. 2 is a block diagram of the automotive tire inflation device provided in the embodiment of the present disclosure.

### MARKS IN THE DRAWINGS

1. inflation hose; 2. sensing module; 3. power supply module; 4. control module; 5. electric inflation module; 6. fixing module; 7. data transmission module.

### DETAILED DESCRIPTION OF THE EMBODIMENTS

The following describes the embodiments of the present disclosure in conjunction with the accompanying drawings.

In the description of the embodiments of the present disclosure, it should be noted that unless otherwise specified and limited, the terms “connection” and “installation” should be understood in a broad sense. For example, “connection” may be detachable or non detachable; it may be directly connected or indirectly connected through intermediate media. In addition, “connectivity” can be direct connectivity or indirect connectivity through intermediate media. Further, “fixed” refers to being connected to each other and the relative position relationship remains unchanged after connection. The directional terms mentioned in the embodiments of the present disclosure, such as “inside”, “outside”, “top”, “bottom”, etc., are only referring to the direction of the accompanying drawings. Therefore, the directional terms used are for better and clearer explanation and understanding of the embodiments of the present disclosure, rather than indicating or implying that the device or element referred to must have a specific orientation, be constructed and operated in a specific orientation, Therefore, it cannot be understood as a limitation on the embodiments of the present disclosure.

In the embodiments of the present disclosure, the terms “first” and “second” are only used to describe the purpose and cannot be understood as indicating or implying relative importance or implying the number of indicated technical features. Therefore, features limited to “first” and “second” can explicitly or implicitly include one or more of these features.

In the embodiments of the present disclosure, “and/or” is simply a description of the association relationship of the associated object, indicating that there can be three types of relationships, for example, A and/or B, which can represent: the existence of A alone, the existence of A and B, and the existence of B alone. In addition, the character ‘/’ in this article generally indicates that the associated object is an ‘or’ relationship.

The reference to “one embodiment” or “some embodiments” described in this specification means that specific features, structures, or features described in conjunction with the embodiment are included in one or more embodiments of the present disclosure. Therefore, the statements “in one embodiment,” “in some embodiments,” and “in other embodiments,” that appear differently in this specification do not necessarily refer to the same embodiment, but rather mean “one or more but not all embodiments” unless otherwise specifically emphasized. The terms “include”, “including”, “having”, and their variations all mean “including but not limited to”, unless otherwise specifically emphasized.

### Embodiment 1

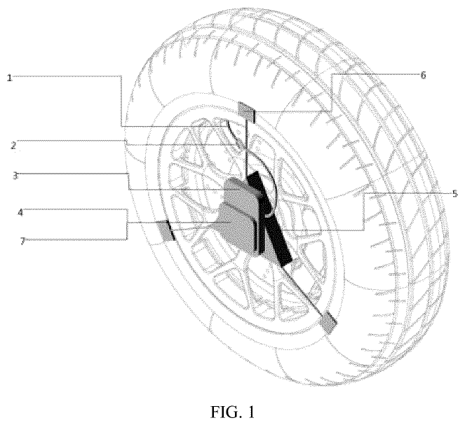

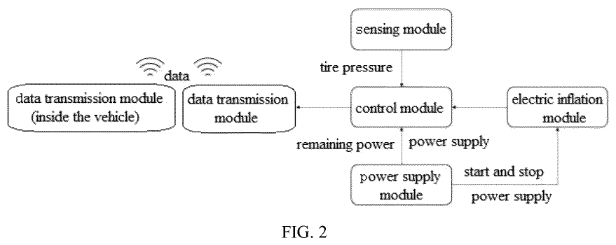

Please refer to FIG. 1 and FIG. 2, an automotive tire inflation device, which includes an electric inflation module 5, a fixing module 6, a power supply module 3, a sensing module 2, a control module 4, and a data transmission module 7.

The electric inflation module 5 is configured to inflate the automotive tire.

The fixing module 6 is fixedly connected to the outer wall of the electric inflation module 5 for fixing the electric inflation module 5 on the wheel hub.

The control module 4 is fixedly connected to the electric inflation module 5, configured to receive inputs from the sensing module 2, continuously monitor changes in tire pressure, and control the start and stop of the electric inflation module 5.

The sensing module 2 is installed on the electric inflation module 5, configured to collect tire pressure and transmit the collected data to the control module 4.

The data transmission module 7 is set on the electric inflation module 5, configured to send start and stop data of inflation and alarm signals to a cabin based on the inputs of the control module 4.

The power supply module 3 is arranged on the electric inflation module 5, configured to provide electricity for the electric inflation module 5, the sensing module 2, the control module 4, and the data transmission module 7. In the above technical solution, the electric inflation module 5, the fixing module 6, the power supply module 3, the sensing module 2, the control module 4, and the data transmission module 7 can be fixed on the wheel hub to make them rotate with the wheel hub, and it facilitates the control of the start and stop of the air pump, and real-time control of the air pump.

Please refer to FIG. 1, the electric inflation module 5 includes an air pump, an inflation hose 1, and an air nozzle. One end of the inflation hose 1 is connected to the outlet end of the air pump, the other end of the inflation hose 1 is connected to the air nozzle, and the air nozzle is connected to a tire valve. In the above technical solution, it can be connected to the tire valve for easy inflation of the tire.

Please refer to FIG. 1, the fixing module 6 includes a plurality of connecting bars fixedly connected to the outer wall of the air pump, with one end of each of the connecting bars far from the air pump contacts with the tire, and each of the connecting bars is fixed to the wheel hub through a plurality of adjustable length steel wires. In the above technical solution, the connecting bars can be fixed to the wheel hub through steel wires, such that the connecting bars are able to rotate together with the wheel hub. It can also be installed in the same way as the existing external mounting counterweight lead block, hooked between the tire and the wheel hub.

Please refer to FIG. 1, the power supply module 3 includes a power supply and a power management module. The power supply is configured to provide electricity to the electric inflation module 5, the sensing module 2, the control module 4, and the data transmission module 7, and the power management module collects power consumption and remaining capacity of the power supply to send to the control module 4. In the above technical solution, the power supply module 3 not only provides power to other modules, but also detects the usage of the power supply through the power management module, making it easy to supplement power timely.

Please refer to FIG. 1, the data transmission module 7 sends a control signal to manually control the start and stop of the electric inflation module 5 to a controller according to a driver instruction. The above technical solution can be manually controlled through the data transmission module 7, making it easy to use.

Please refer to FIG. 1, each of the connecting bars is a retractable connecting bar. In the above technical solution, the setting of the retractable connecting bars can facilitate the use of wheels of different sizes, and the other end of the retractable connecting bar is fixedly connected with a contact plate, which contacts with the tire to further fix it.

However, as those skilled in the art are familiar with, the working principles and wiring methods of the electric inflation module 5, the fixing module 6, the power supply module 3, the sensing module 2, the control module 4, and the data transmission module 7 are common and belong to conventional methods or common knowledge, and will not be described here for brevity. Those skilled in the art can make any selection according to their needs or convenience.

The working principle and usage process of this technical solution are as follows: during use, the connecting bars are fixed on the wheel hub through steel wires, the air nozzle is inserted into the tire valve, and the changes in tire pressure are continuously monitored through the sensing module 2. When the tire pressure is below the threshold, the control module 4 outputs a control signal to drive the electric inflation module 5 to inflate the tire. If the tire pressure of the vehicle continues to decrease during inflation, the control module 4 will generate an alarm signal. If abnormal power consumption or insufficient remaining power is detected by the power supply module 3, the control module 4 will generate an alarm signal. The control module 4 is also responsible for driving the operation of the data transmission module 7, and outputting the start and stop of the electric inflation module 5, the power consumption of the power supply module 3, the remaining power of the power supply, and various alarm signals to the data transmission module 7, making it convenient to use.

The above is only the specific embodiments of the present disclosure, but the scope of the present disclosure is not limited to this. Any skilled person in the art can understand that those changes or replacements within the scope of disclosure of the present disclosure, which should be covered within the scope of the present disclosure. Without conflict, the embodiments of the present disclosure and the features in the embodiments can be combined with each other. Therefore, the scope of the present disclosure should be based on the scope of the claims

What is claimed is:

1. An automotive tire inflation device, comprising: an electric inflation module (5), a fixing module (6), a power supply module (3), a sensing module (2), a control module (4), and a data transmission module (7);
wherein the electric inflation module (5) is configured to inflate the tire;
the fixing module (6) is fixedly connected to an outer wall of the electric inflation module (5) for fixing the electric inflation module (5) on a wheel hub;
the control module (4) is fixedly connected to the electric inflation module (5), configured to receive inputs from the sensing module (2), continuously monitor changes in tire pressure, and control the start and stop of the electric inflation module (5);
the sensing module (2) is installed on the electric inflation module (5), configured to collect tire pressure and transmit the collected data to the control module (4);
the data transmission module (7) is set on the electric inflation module (5), configured to send start and stop data of inflation and alarm signals to a cabin based on the inputs of the control module (4); and
the power supply module (3) is arranged on the electric inflation module (5), configured to provide electricity for the electric inflation module (5), the sensing module (2), the control module (4), and the data transmission module (7).

2. The automotive tire inflation device according to claim 1, wherein the electric inflation module (5) comprises an air pump, an inflation hose (1), and an air nozzle; one end of the inflation hose (1) is connected to an outlet end of the air pump, an other end of the inflation hose (1) is connected to the air nozzle, and the air nozzle is connected to a tire valve.

3. The automotive tire inflation device according to claim 2, wherein the fixing module (6) comprises a plurality of connecting bars fixedly connected to the outer wall of the air pump, with one end of each of the connecting bars far from the air pump contacts with the tire, and each of the connecting bars is fixed to the wheel hub through a plurality of adjustable length steel wires.

4. The automotive tire inflation device according to claim 1, wherein the power supply module (3) comprises a power supply and a power management module; the power supply is configured to provide electricity to the electric inflation module (5), the sensing module (2), the control module (4), and the data transmission module (7); and the power management module collects power consumption and remaining capacity of the power supply to send to the control module (4).

5. The automotive tire inflation device according to claim 1, wherein the data transmission module (7) sends a control signal to manually control the start and stop of the electric inflation module (5) to a controller according to a driver instruction.

6. The automotive tire inflation device according to claim 3, wherein each of the connecting bars is a retractable connecting bar.
